(19) United States
(12) Patent Application Publication
(10) Pub. No.: US 2014/0136669 A1
(43) Pub. Date: May 15, 2014

(54) METHOD OF OPERATING USER DEFINED COMPLEX CONTEXT INFORMATION CONSTITUTION SYSTEM

(71) Applicant: Electronics and Telecommunications Research Institute, Daejeon (KR)

(72) Inventors: Eung Ha KIM, Daejeon (KR); Su Kyung KIM, Daejeon (KR)

(73) Assignee: Electronics and Telecommunications Research Institute, Daejeon (KR)

(21) Appl. No.: 13/975,855

(22) Filed: Aug. 26, 2013

(30) Foreign Application Priority Data
Nov. 14, 2012 (KR) 10-2012-0128848

(51) Int. Cl. H04L 12/24

(52) U.S. Cl. CPC H04L 41/0806
USPC 709/222

(57) ABSTRACT

Embodiments provide a method for operating a user defined complex context information constitution system which provides a user defined complex context information user interface to an application service developer in order to support an environment required for complex context information development and performs a developed application service using the user defined complex context information so as to easily create, register, change, and delete user defined complex context information corresponding to an arbitrary service.

### CROSS-REFERENCE TO RELATED APPLICATIONS

This application claims priority to and the benefit of Korean Patent Application No. 10-2012-0128848 filed in the Korean Intellectual Property Office on Nov. 14, 2012, the entire contents of which are incorporated herein by reference.

### TECHNICAL FIELD

Embodiments relate to a method of operating a user defined complex context information constitution system, and more specifically, to a method of operating a user defined complex context information constitution system which easily creates, registers, changes, and deletes user defined complex context information corresponding to an arbitrary service.

### BACKGROUND ART

Generally, when complex context information is provided for a context awareness service rather than simple context information, it is possible to provide a more practical and appropriate service in order to be applied to a real world service environment.

If the complex context information is not provided, a terminal device directly selects, negotiates, and combines unit services so that so many overhead accompanied with a service to be operated occurs and individual service providers disadvantageously excessively spend redundant development cost accompanied with an independent service development for the same context information.

Therefore, in recent years, a technology related to a complex context information processing system which is capable of efficiently developing a context awareness service is being studied. However, the complex context information processing system of the related art cannot provide all complex context information required for all context awareness services but provides only basic complex context information.

Specifically, in a study related to a service infra using the complex context information, a method of separating a common function required for development of complex context application service from an application level to provide the common function to an application service developer as complex context information providing infra is being studied. However, only unit context information is provided or even though complex context information is provided, the current context information providing infra provides only limited complex context information which is defined in advance in the system so that the application service developer cannot appropriately use the complex context information.

### SUMMARY OF THE INVENTION

The present invention has been made in an effort to provide a method of operating a user defined complex context information constitution system which easily creates, registers, changes, and deletes user defined complex context information corresponding to an arbitrary service.

A first exemplary embodiment provides a method of operating a user defined complex context information constitution system, including: inputting a registration request for user defined complex context information corresponding to an arbitrary service and a name and a description of the user defined complex context information by an arbitrary terminal device; transmitting a system defined complex context information list which is registered in advance in accordance with the service to the terminal device and determining whether a selection command for arbitrary system defined complex context information from the system defined complex context information list is input from the terminal device; when the selection command is input, transmitting screen information on a constitutional screen including unit context information from a system defined complex context information constitution table and rule information from a system defined complex context information rule table to the terminal device; receiving the user defined complex context information in which at least one of arbitrary unit context information of the unit context information and arbitrary rule information of the rule information is added to the arbitrary system defined complex context information, unique information, and a selected registration command language from the terminal device; and registering the user defined complex context information and transmitting the registration completion to the terminal device, based on the user defined complex context information, the unique information, and the registration command language.

A second exemplary embodiment provides a method of operating a user defined complex context information constitution system, including: transmitting arbitrary user defined complex context information selected from user defined complex context information which is registered in advance, when an arbitrary terminal device inputs a request to change user defined complex context information corresponding to an arbitrary service; transmitting screen information on a constitutional screen including unit context information from a user defined complex context information constitution table and rule information from a user defined complex context information rule table to the terminal device; receiving the user defined complex context information in which at least one of arbitrary unit context information of the unit context information and arbitrary rule information of the rule information is added to the arbitrary user defined complex context information, unique information, and a selected changing command language, from the terminal device; and transmitting the change registration completion for the user defined complex context information to the terminal device, based on the user defined complex context information, the unique information, and the changing command language.

A third exemplary embodiment provides a method of operating a user defined complex context information constitution system, including: transmitting arbitrary user defined complex context information selected from user defined complex context information which is registered in advance, when an arbitrary terminal device inputs a request to delete user defined complex context information corresponding to an arbitrary service; transmitting screen information on a constitutional screen including unit context information from a user defined complex context information constitution table and rule information from a user defined complex context information rule table to the terminal device; receiving a name, unique information, and a deleting command language from the terminal device for the arbitrary user defined complex context information; and when there are the same name as the name and the same unique information as the unique information, deleting the arbitrary user defined complex context information from a user defined complex context information list table, a user defined complex context information constitution table, and a user defined complex context information rule table in accordance with the deleting command language and transmitting the deleting completion to the terminal device.

A fourth exemplary embodiment provides a method of operating a user defined complex context information constitution system, including: searching arbitrary user defined complex context information which matches a user defined complex context information condition including a name of input user defined complex context information and a user defined identification mark field when an arbitrary terminal device inputs a request to search the user defined complex context information; confirming whether the identification mark field is user defined complex context information and determining whether there is the arbitrary user defined complex context information having the same name as the name in the user defined complex context information list table included in a user defined complex context information repository; if the arbitrary user defined complex context information is present, extracting information related to the name from the complex context information constitution table and the complex context information rule table included in the user defined complex context information repository to constitute an ontology database query language; and transmitting all information on the arbitrary user defined complex context information from the context information ontology database based on the ontology database query language to the terminal device.

The method of operating a user defined complex context information constitution system according to the exemplary embodiment creates new user defined complex context information by adding other unit context information and rule information based on the system defined complex context information which is registered in advance and the user defined complex context information which is registered in advance so that various context awareness services are easily developed and the developed context awareness service is shared to build an open service development environment.

The method of operating a user defined complex context information processing system according to the exemplary embodiment creates complex context information centered on the user using an application developer terminal device so that a new service area may be created in a communication service field.

The method of operating a user defined complex context information processing system according to the exemplary embodiment creates or manufactures other user defined complex context information, based on the system defined complex context information which is registered in advance and the user defined complex context information which is registered in advance so that the reusability for the complex context information is improved and it is advantageous in the view of the context awareness service development cost and the context recognition service development.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a conceptual view schematically illustrating a user defined complex context information providing scenario using a user defined complex context information constitution system according to an exemplary embodiment.

FIG. 2 is a screen view illustrating a user interface screen for an arbitrary terminal device of the user defined complex context information constitution system according to the exemplary embodiment.

FIG. 3 is a view illustrating main components and a relationship of a user defined complex context information list table, a user defined complex context information constitution table, and a complex context information rule table which are configured by the user defined complex context information constitution system according to the exemplary embodiment.

FIGS. 4 and 5 are flowcharts illustrating a method of operating a user defined complex context information constitution system according to a first exemplary embodiment.

FIG. 6 is a flowchart illustrating a method of operating a user defined complex context information constitution system according to a second exemplary embodiment.

FIG. 7 is a flowchart illustrating a method of operating a user defined complex context information constitution system according to a third exemplary embodiment.

FIG. 8 is a flowchart illustrating a method of operating a user defined complex context information constitution system according to a fourth exemplary embodiment.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

In the description of components of an exemplary embodiment, a component having the same name may be denoted by a different reference numeral in some drawings but may be denoted by the same reference numeral even in different drawings. However, even in this case, it does not mean that the component has different functions depending on the exemplary embodiment or the components have the same function in the different exemplary embodiments but the function of each of the components may be determined based on the description of the components in the corresponding exemplary embodiment.

In the description of the exemplary embodiment, if it is considered that specific description of related known configuration or function may cloud the gist of the present invention, the detailed description will be omitted.

In the description of the components of the exemplary embodiment, a terminology such as a first, a second, A, B, (a), and (b) may be used. The terminology is used to distinguish a component from the other components but a nature or an order of the component is not limited by the terminology. If it is described that a component is “connected” or “coupled” or “accessed” to the other component, it is understood that the component is directly connected or coupled to the other component but another component may be “connected” or “coupled” or “accessed” between the components.

Hereinafter, parts required for understanding an operation and an effect of a complex context information constitution system and an operating method thereof according to an exemplary embodiment will be described in detail with reference to the drawings.

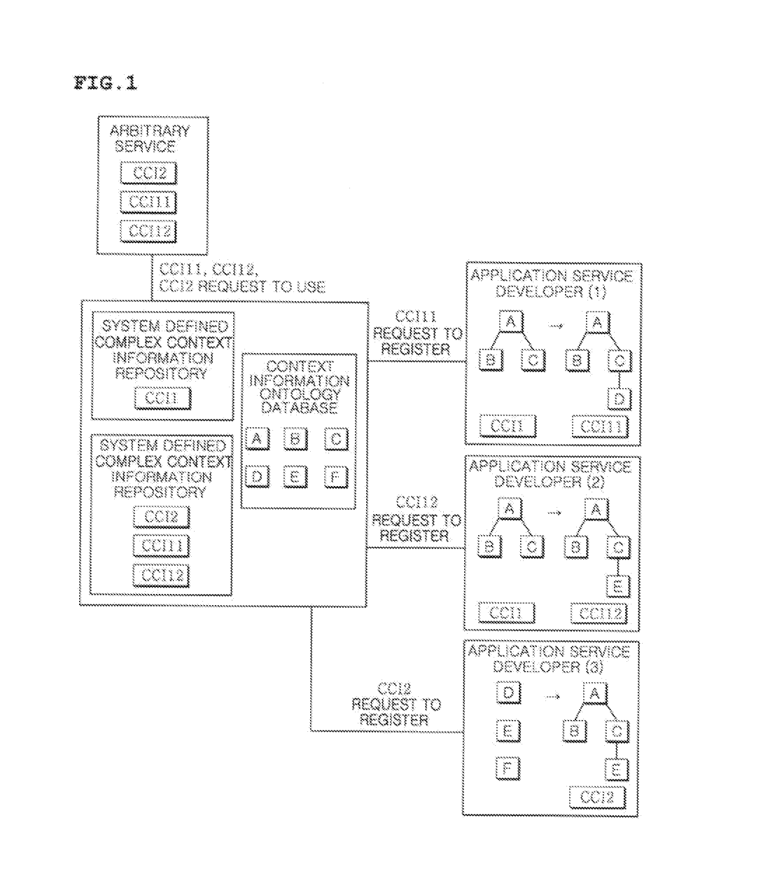

FIG. 1 is a conceptual view schematically illustrating a user defined complex context information providing scenario using a complex context information constitution system according to an exemplary embodiment.

FIG. 1 is a conceptual view of a user defined complex context information providing scenario using a user defined complex context information constitution system which performs a user defined complex context information interface control function which provides a user interface environment, which newly creates, changes, deletes, and searches user defined complex context information, to an application service developer, a user defined complex context information translating function which analyzes a requested user defined complex context information processing command language, a user defined complex context information constitution function which adds, changes, deletes, and searches the corresponding user defined complex context information in a user defined complex context information repository including user defined complex context information constitution information and rule information, in accordance with the requested user defined complex context information processing command language, and a request to process the user defined complex context information from the application service.

Referring to FIG. 1, the user defined complex context information constitution system 100 allows an application service developer, that is, an arbitrary terminal device to additionally register new user defined complex context information, which is suitable for an arbitrary service, using system defined complex context information, user defined complex context information or unit context information which is registered in advance, so that enriched context information is provided so as to plentifully use the context information.

Here, the user defined complex context information constitution system 100 includes a system defined complex context information repository 110 which includes system defined complex context information CCI1 corresponding to the arbitrary service, a user defined complex context information repository 120 which includes user defined complex context information CCI2, CCI11, and CCI12 corresponding to the arbitrary service, and a context information ontology database 130 which includes a plurality of unit context information A, B, C, D, E, and F.

In other words, an application service developer 1 which uses the system defined complex context information CCI1 corresponding to the arbitrary service may add the unit context information D to the system defined complex context information CCI1 to create new user defined complex context information CCI11 and an application service developer 2 may add the unit context information E to the system defined complex context information CCI1 to create new user defined complex context information CCI12.

An application service developer 3 uses the unit context information D, E, and F to create new user defined complex context information CCI2 and the application service developer 3 may use all of the system defined complex context information CCI1, the user defined complex context information CCI11, the user defined complex context information CCI12, and the user defined complex context information CCI2.

Specifically, the user defined complex context information constitution system 100 may include a system defined complex context information repository 110 which provides a system defined complex context information list table, a system defined complex context constitution list table, and a system defined complex context constitution rule list table, a user defined complex context information repository 120 which provides a user defined complex context information list table, a user defined complex context constitution list table, and a user defined complex context constitution rule list table, and a unit context ontology database 130 which provides a unit context information list.

Here, the user defined complex context information constitution system 100 may allow the application service developers 1 to 3 (hereinafter, referred to as an “arbitrary terminal device”) to register, change, delete, and search new user defined complex context information in accordance with the system defined complex context information and the user defined complex context information which are registered in advance.

That is, the arbitrary terminal devices 1 to 3 may input a name and description corresponding to the user defined complex context information to the user defined complex context information system in order to register the newly created user defined complex context information.

Thereafter, the user defined complex context information constitution system 100 transmits either the unit context information so as to be selected from the unit context information list table or the complex context information in order to select the complex context information from the system defined complex context information list or the user defined complex context information list which is registered in advance and become a basis of the user defined complex context information to the arbitrary terminal device for create new complex context information which has not been registered in advance.

In the case of first registration, if the arbitrary terminal device 1 to 3 selects arbitrary system defined complex context information from the system defined complex context information list, the user defined complex context information constitution system 100 performs the user defined complex context information interface control function to receive arbitrary unit context information, which constitutes the arbitrary system defined complex context information selected by the arbitrary terminal device 1 to 3, from the system defined complex context information constitution table included in the system defined complex context information registry 110 and arbitrary rule information which is configured by a value of the arbitrary unit context information and a logical operator (and or or) and describes a condition of the arbitrary system defined complex context information selected by the arbitrary terminal device 1 to 3 from the system defined complex context information rule table to configure the user defined complex context information constitutional screen.

In this case, the arbitrary terminal device 1 to 3 selects new unit context information to be added from the unit context information list to add the new unit context information to the arbitrary unit context information which configures the arbitrary system defined complex context information. Thereafter, in order to register new user defined complex context information which is configured by the rule information of the user defined complex context information which is created by adding the added unit context information value and the logical operator, basic information including a user identifier and a password is input and then a registered command language is selected from the user defined complex context information constitution providing command language.

The basic information is used when a deleting and changing command language of the created user defined complex context information is requested and only user defined complex context information which is created by the user is processed.

The user defined complex context information constitution system 100 performs the user defined complex context information interface control function which receives a registration command language from the arbitrary terminal device 1 to 3 to search the system defined complex context information list table and the user defined complex context information list table which are registered in advance to confirm whether arbitrary user defined complex context information having the same name as the name of the newly registered user defined complex context information is present.

Thereafter, if the arbitrary user defined complex context information is present, the user defined complex context information constitution system 100 transmits an error message to the arbitrary terminal device 1 to 3. In contrast, if the arbitrary user defined complex context information is not present, the user defined complex context information constitution system 100 performs the user defined complex context information constitution function.

In this case, the user defined complex context information constitution system 100 adds the name of the user defined complex context information received by performing the user defined complex context information constitution function and information on an identifier and a password of a manufacturing user to the user defined complex context information list table. The user defined complex context information constitution system 100 further adds the unit context information which constitutes the received user defined complex context information to the user defined complex context information constitution table and adds the rule information of the received user defined complex context information to the user defined complex context information rule table and performs the user defined complex context information interface control function to transmit a registration completing message to the arbitrary terminal device 1 to 3.

In the case of second registration, if the arbitrary terminal device 1 to 3 selects arbitrary user defined complex context information from the user defined complex context information list, the user defined complex context information constitution system 100 performs the user defined complex context information interface control function to receive arbitrary unit context information, which constitutes the arbitrary user defined complex context information selected by the arbitrary terminal device 1 to 3, from the user defined complex context information constitution table included in the user defined complex context information registry 130 and arbitrary rule information which is configured by a value of the arbitrary unit context information and a logical operator (and or or) and describes a condition of the arbitrary user defined complex context information selected by the arbitrary terminal device 1 to 3 from the user defined complex context information rule table to configure the user defined complex context information constitutional screen.

In this case, the arbitrary terminal device 1 to 3 selects new unit context information to be added from the unit context information list to add the new unit context information to the arbitrary unit context information which configures the arbitrary user defined complex context information. Thereafter, in order to register new user defined complex context information which is configured by the rule information of the user defined complex context information which is created by adding the added unit context information value and the logical operator, basic information including a user identifier and a password is input and then a registered command language is selected from the user defined complex context information constitution providing command language.

The basic information is used when a deleting and changing command language of the created user defined complex context information is requested and only user defined complex context information which is created by the user is processed.

The user defined complex context information constitution system 100 performs the user defined complex context information interface control function which receives a registration command language from the arbitrary terminal device 1 to 3 to search the user defined complex context information list table and the user defined complex context information list table which are registered in advance to confirm whether arbitrary user defined complex context information having the same name as the name of the newly registered user defined complex context information is present.

Thereafter, if the arbitrary user defined complex context information is present, the user defined complex context information constitution system 100 transmits an error message to the arbitrary terminal device 1 to 3. In contrast, if the arbitrary user defined complex context information is not present, the user defined complex context information constitution system 100 performs the user defined complex context information constitution function.

In this case, the user defined complex context information constitution system 100 adds the name of the user defined complex context information received by performing the user defined complex context information constitution function and information on an identifier and a password of a manufacturing user to the user defined complex context information list table. The user defined complex context information constitution system 100 further adds the unit context information which constitutes the received user defined complex context information to the user defined complex context information constitution table and adds the rule information of the received user defined complex context information to the user defined complex context information rule table and performs the user defined complex context information interface control function to transmit a registration completing message to the arbitrary terminal device 1 to 3.

In the case of third registration, if the arbitrary terminal device 1 to 3 selects unit context information which needs to be included in a user defined complex context information constitution which will be newly registered from the unit context information list included in the context information ontology database, the user defined complex context information constitution system 100 inputs the user identifier and the password and then selects a registration command language among the user defined complex context information constitution providing command languages in order to register new user defined complex context information including user defined complex context information rule information created by adding a value of the selected unit context information and a logical operator, and then operates similarly to the first or second registration case.

If the arbitrary terminal device 1 to 3 selects user defined complex context information to be changed from the user defined complex context information list in order to change the user defined complex context information which is registered in advance, the user defined complex context information constitution system 100 performs the user defined complex context information interface control function to transmit the unit context information which configures the user defined complex context information selected by the arbitrary terminal device 1 to 3 from the user defined complex context information constitution table included in the user defined complex context information registry 120 and transmit the rule information of the complex context information selected by the arbitrary terminal 1 to 3 from the user defined complex context information rule table to allow the arbitrary terminal device 1 to 3 to output the user defined complex context information constitutional screen.

Thereafter, the arbitrary terminal device 1 to 3 refers to the unit context information which configures the output user defined complex context information and inputs a name of the user defined complex context information and the user identifier and the password and then selects the changing command language among the user defined complex context information constitution providing command languages in order to change the transmitted user defined complex context information referring to the rule information of the new user defined complex context information created by changing the value of the unit context information or the logical operator which configures the rule information.

When the changing command language is received, the user defined complex context information constitution system 100 performs the user defined complex context information interface control function to search the user defined complex context information list table to search whether there is the user defined complex context information having the same name as the name of the user defined complex context information which is requested to be changed.

If there is no same user defined complex context information name as a searching result, the user defined complex context information constitution system 100 outputs the error message on the user defined complex context information constitutional screen to be transmitted to the arbitrary terminal device 1 to 3.

In contrast, if there is the same user defined complex context information name, the user defined complex context information constitution system 100 compares whether the user identifier and the password are equal to the received user identifier and password. If the user identifier and the password are not equal to the received user identifier and password as a comparing result, the user defined complex context information constitution system 100 outputs the error message on the user defined complex context information constitutional screen to be transmitted to the arbitrary terminal device 1 to 3. If the user identifier and the password are equal to the received user identifier and password as a comparing result, the user defined complex context information constitution system 100 performs the user defined complex context information constitution function on the received changing command language and the rule information of the newly changed user defined complex context information to change the rule information of the user defined complex context information which is registered in advance in the user defined complex context information rule table into the rule information of the received user defined complex context information and performs the user defined complex context information interface control function of the change completion message.

When the user defined complex context information interface control function is performed, the user defined complex context information constitution system 100 outputs the change completion message onto the user defined complex context information constitutional screen to notify the arbitrary terminal device 1 to 3.

In order to delete the registered user defined complex context information, the arbitrary terminal device 1 to 3 selects the complex context information to be deleted in the user defined complex context information list, inputs the user identifier and the password, and then selects a deletion command language among the user defined complex context information constitution providing command languages.

When the deletion command language is received, the user defined complex context information constitution system 100 performs an interface control function to search the user defined complex context information list table to search whether there is the user defined complex context information having the same name as the name of the user defined complex context information which is requested to be deleted.

If there is no same name as a searching result, the user defined complex context information constitution system 100 outputs the error message on the user defined complex context information constitutional screen to be transmitted to the arbitrary terminal device 1 to 3.

If there is the same name, the user defined complex context information constitution system 100 compares whether the identifier and the password of the user who creates the user defined complex context information are equal to the received user identifier and password. If the identifier and the password are not equal to the received user identifier and password, the user defined complex context information constitution system 100 outputs the error message on the user defined complex context information constitutional screen to be transmitted to the arbitrary terminal device 1 to 3. If the identifier and the password are equal to the received user identifier and password as a comparing result, the user defined complex context information constitution system 100 performs the user defined complex context information constitution function on the received deletion command language and the user defined complex context information to be requested to be deleted to delete the rule information of the user defined complex context information which is requested to be deleted in the user defined complex context information rule table and then delete the constitution information of the user defined complex context information which is requested to be deleted in the user defined complex context information constitution table, and then delete the complex context information which is requested to be deleted from the user defined complex context information list table, and performs the user defined complex context information interface control function to transmit the deleting completion message to the arbitrary terminal device 1 to 3.

In the meantime, the arbitrary terminal device 1 to 3 requests to search all information which matches the user defined complex context information condition including the user defined complex context information name and the user defined identification mark field in order to use the newly created user defined complex context information in the application service.

In this case, when the search request is received, the user defined complex context information constitution system 100 performs the complex context information processing function to confirm whether the identification mark field of the received complex context information is user defined identification mark field, search whether there is the same name in the user defined complex context information list table included in the user defined complex context information repository 120 and if there is no same user defined complex context name as a result of search, transmit an error message to the application service.

In contrast, if there is the same user defined complex context information name as the search result, the user defined complex context information constitution system 100 extracts information related to the received name from the user defined complex context information constitution table which is connected to the user defined complex context information list table and from the user defined complex context information rule table to configure an ontology database query language to transmit all information which matches the user defined complex context information condition received by searching the context information ontology database to the application service.

The user defined complex context information constitution system 100 may process a corresponding service using information related to the user defined complex context information in the application service.

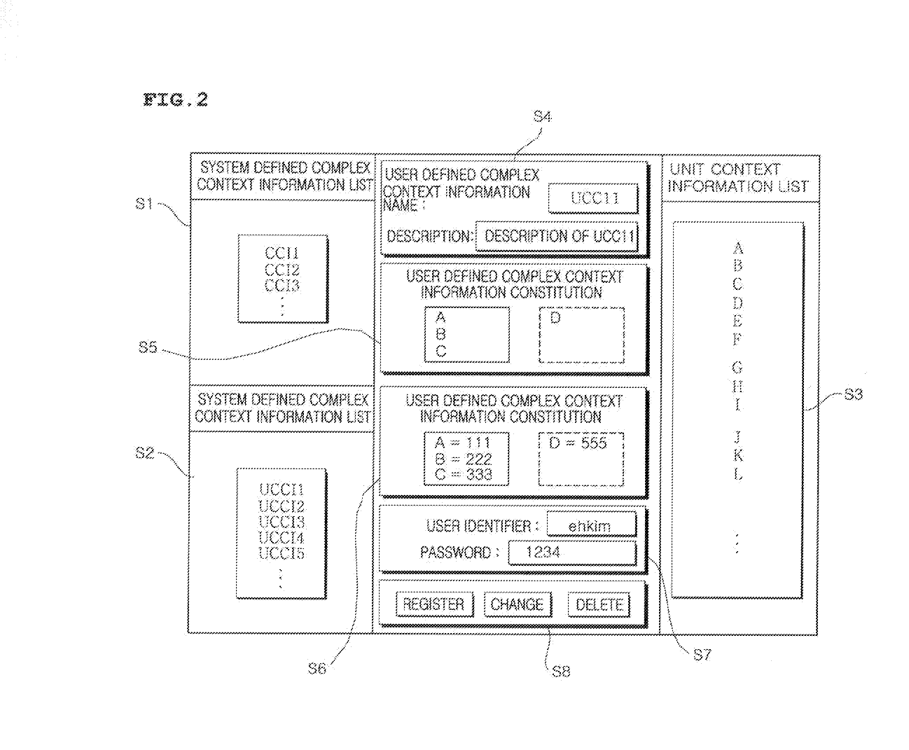

FIG. 2 is a screen view illustrating a user interface screen for an arbitrary terminal device of the user defined complex context information constitution system according to the exemplary embodiment.

Referring to FIG. 2, a user interface screen of the user defined complex context information constitution system 100 may include an area S1 which shows a system defined complex context information list, an area S2 which shows a user defined complex context information list, an area S3 which shows a unit context information list, an area S4 in which a name and a description of user defined complex context information which will be newly created are input, an area S5 in which a component of the user defined complex context information which will be newly created is added, an area S6 in which the rule information of the user defined complex context information to be newly created is added, an area S7 in which the user identifier and the password are input, and an area S8 which selects the registration, change, or deletion command language.

Here, if any one of the complex context information is selected from the system defined complex context information list and the user defined complex context information list, the component and the rule information of the selected complex context information are output to the area S5 and the rule information area S6 in which the component of the user defined complex context information to be newly created is added. The arbitrary terminal device 1 to 3 selects unit context information required for the user defined complex context information to be newly created from the unit context information list to add the unit context information to the constitution information area of the screen and adds the value of the unit context information and the logical operator in the rule information area.

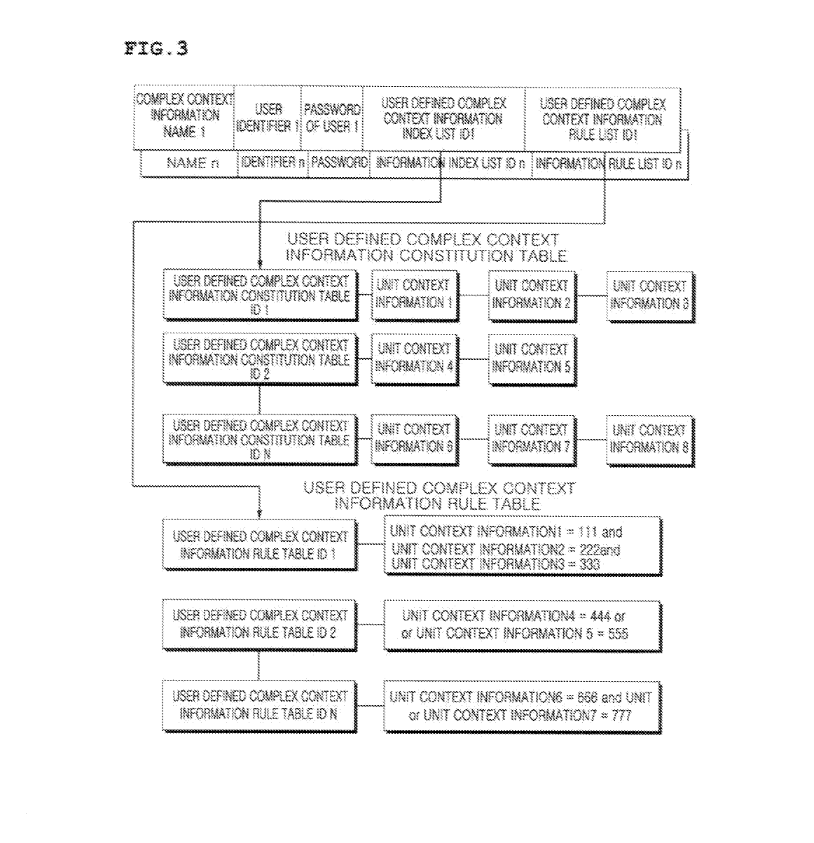

FIG. 3 is a view illustrating a main components and a relationship of the user defined complex context information list table, the user defined complex context information constitution table, and the user defined complex context information rule table which are configured by the user defined complex context information constitution system according to the exemplary embodiment.

Referring to FIG. 3, the user defined complex context information list table is configured by a user defined complex context information constitution table ID which is a location where the lists of the user defined complex context information name, the user identifier and password which are input to the user interface of the user defined complex context information constitution system 100, and unit context information which is a component corresponding to the user defined complex context information name are stored and a user defined complex context information rule table ID which is a location where the rule information corresponding to the user defined complex context information name is stored.

The user defined complex context information constitution table is configured by a user defined complex context information constitution table ID which is an identification number which distinguishes constitution information of the user defined complex context information and information of unit contexts which configures the user defined complex context information.

The user defined complex context information rule table is configured by a complex context information rule list ID which is an identification number which distinguishes rule information of the user defined complex context information and information of rules which constitutes the complex context information.

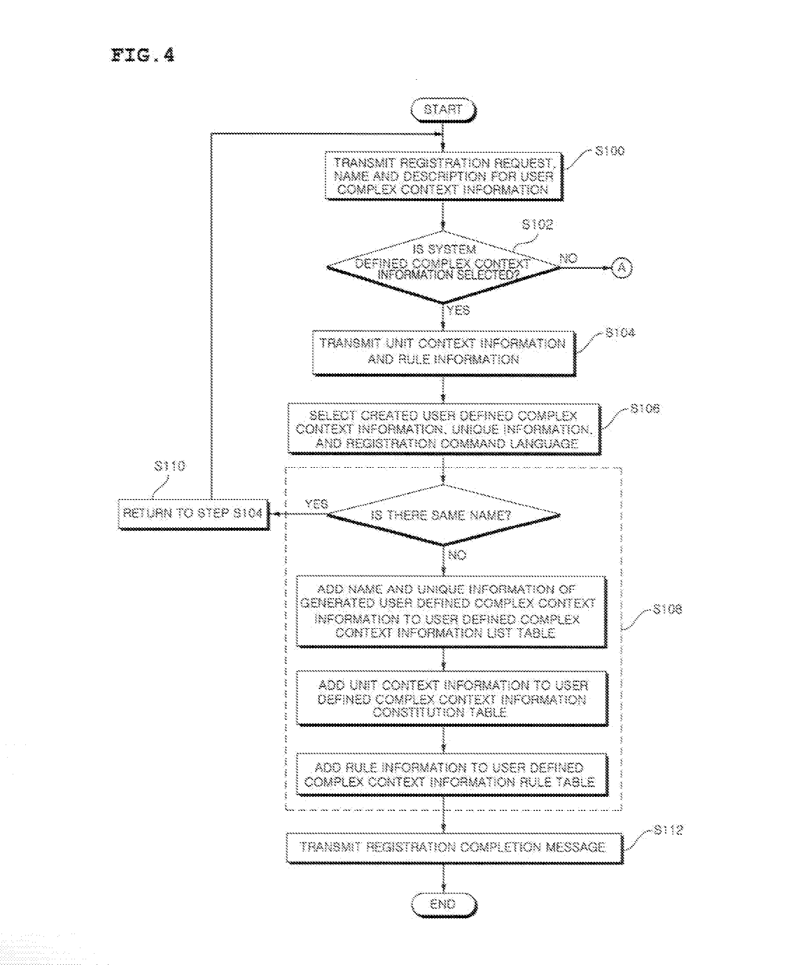

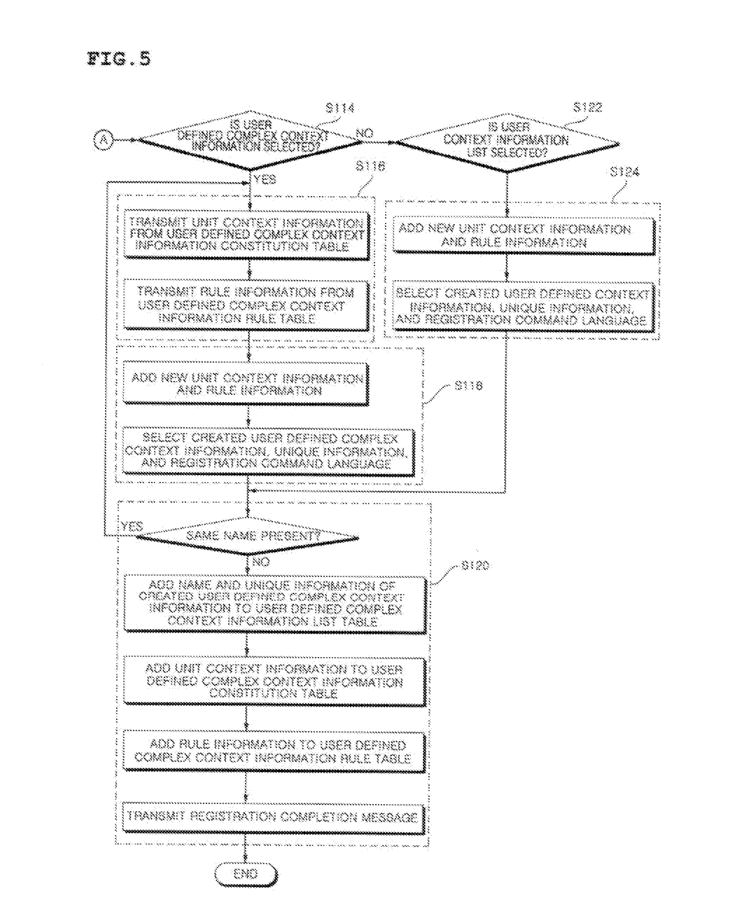

FIGS. 4 and 5 are flowcharts illustrating a method of operating a user defined complex context information constitution system according to a first exemplary embodiment.

First, FIGS. 4 and 5 illustrate an operating method of the arbitrary terminal device which registers the user defined complex context information.

Referring to FIGS. 4 and 5, in step S100, a request for registering the user defined complex context information and the name and description of the user defined complex context information are input and transmitted from the arbitrary terminal device. In step S102, the system defined complex context information list which is registered in advance is transmitted to the terminal device and whether a selection command of arbitrary system defined complex context information from the system defined complex context information list is input from the terminal device is determined.

That is, the system defined complex context information constitution system 100 receives the registration request, a name and a description of the user defined complex context information transmitted from the arbitrary terminal device and transmits the system defined complex context information list which is registered in advance.

In this case, the system defined complex context information constitution system 100 receives a signal regarding whether to select the arbitrary system defined complex context information from the system defined complex context information list, which is transmitted from the terminal device to determine whether to select the arbitrary system defined complex context information.

First, if it is determined that the selection command is input in step S102, in step S104, screen information on a constitutional screen including unit context information from a system defined complex context information constitution table and rule information from a system defined complex context information rule table is transmitted to the terminal device.

That is, when the selection command is input, the system defined complex context information constitution system 100 performs the user defined complex context information interface control function to transmit the unit context information which constitutes the arbitrary system defined complex context information selected by the terminal device from the system defined complex context information constitution table included in the system defined complex context information repository 110, and transmit the rule information, which describes the condition of the arbitrary system defined complex context information selected by the terminal device from the system defined complex context information rule table included in the system defined complex context information repository 110 and includes the value of the unit context information and the logical operator, to the terminal device so as to be constituted as the screen of the terminal device.

Thereafter, in step S106, the terminal device selects new unit context information which will be newly added to the unit context information list for the unit context information which constitutes the transmitted arbitrary system defined complex context information, adds a value of the added unit context information and a logical operator to create rule information of the user defined complex context information to transmit the newly created user defined complex context information, unique information, and a selected registration command language. If the arbitrary user defined complex context information having the same name as the name is not present in the user defined complex context information which is registered in advance, in step S108, the name of the user defined complex context information and the unique information are added to the user defined complex context information list table, the unit context information of the user defined complex context information is added to the user defined complex context information constitution table, and the rule information of the user defined complex context information is added to the user defined complex context information rule table. If the arbitrary user defined complex context information having the same name as the name is present, the error information is transmitted to the terminal device and the procedure returns to step S100 or ends.

In step S112, the user defined complex context information is registered and the registration completion is transmitted to the terminal device, based on the user defined complex context information, the unique information, and the registration command language.

That is, the terminal device adds the value of the unit context information which is added by selecting new unit context information to be added from the unit context information list and the logical operator to the unit context information transmitted from the user defined complex context information constitution system 100 to create the rule information of the user defined complex context information and inputs the unique information including the user identifier and password and selects the registration command language among the user defined complex context information constitution providing command languages in order to register the newly created user defined complex context information to be transmitted to the user defined complex context information constitution system 100.

The user defined complex context information constitution system 100 performs the user defined complex context information interface control function to search the registration command language transmitted from the terminal device, the system defined complex context information list table, and the user defined complex context information list table which are registered in advance to search whether there is the same name.

In this case, if there is the same name as the search result, the user defined complex context information constitution system 100 transmits the error information to the terminal device to constitute the screen.

If the same name is not present, the user defined complex context information constitution system 100 performs the user defined complex context information constitution function on the received registration command language and the newly created user defined complex context information to add information on the name of the newly created user defined complex context information, and the user identifier and password to the user defined complex context information list table, add the unit context information which constitutes the received user defined complex context information to the user defined complex context information constitution table, and add the rule information of the received user defined complex context information to the user defined complex context information rule table. The user defined complex context information constitution system 100 performs the user defined complex context information interface control function to transmit the registration completion message to the terminal device to notify the terminal device that the registration is completed.

If the selection command is not input in step S102, in step S114, it is determined whether the selection command for the arbitrary user defined complex context information from the user defined complex context information list which is registered in advance is input. If the selection command is input, in step S16, the screen information on the constitutional screen including the unit context information from the user defined complex context information constitution table and the rule information from the user defined complex context information rule table is transmitted to the terminal device. In step S118, the user defined complex context information obtained by adding at least one of the arbitrary unit context information of the unit context information and the arbitrary rule information of the rule information to the arbitrary user defined complex context information, the unique information, and the selected registration command language are transmitted from the terminal device. In step S120, the user defined complex context information is registered based on the user defined complex context information, the unique information, and the registration command language and the registration completion is transmitted to the terminal device.

That is, when the arbitrary user defined complex context information included in the user defined complex context information list is selected from the terminal device, the user defined complex context information constitution system 100 performs the user defined complex context information interface control function to transmit the arbitrary unit context information which constitutes the arbitrary user defined complex context information selected by the terminal device from the user defined complex context information constitution table included in the user defined complex context information repository 120 and the rule information of the arbitrary complex context information which constitutes the arbitrary user defined complex context information from the user defined complex context information rule table to the terminal device to constitute the screen.

In this case, the terminal device transmits the unique information including the user identifier and password and the registration command language for registering the new user defined complex context information constituted by the rule information of the user defined complex context information by adding the value of the unit context information which is added by receiving the new unit context information to be in the arbitrary unit context information list transmitted from the user defined complex context information constitution system 100 from the context information ontology database and the logical operator to the user defined complex context information constitution system 100.

When the registration command language is received, the user defined complex context information constitution system 100 determines whether to register as described above to register the newly created user defined complex context information.

In step S114, if the selection command is not input, in step S122, the unit context information list included in the context information ontology database 130 is transmitted to the terminal device and it is determined whether the selection command for the arbitrary unit context list from the unit context information list is input from the terminal device.

Thereafter, if the selection command is not input, the procedure ends. If the selection command is input, in step S124, the selected unit context information is added to the user defined complex context information which is newly created in the terminal device and the value of the unit context information and the logical operator are added to transmit the user defined complex context information to which the rule information of the user defined complex context information is added, the unique information including the user identifier and password, and the registration command. Whether to register the newly created user defined complex context information is the same as the above description and the redundant description will be omitted.

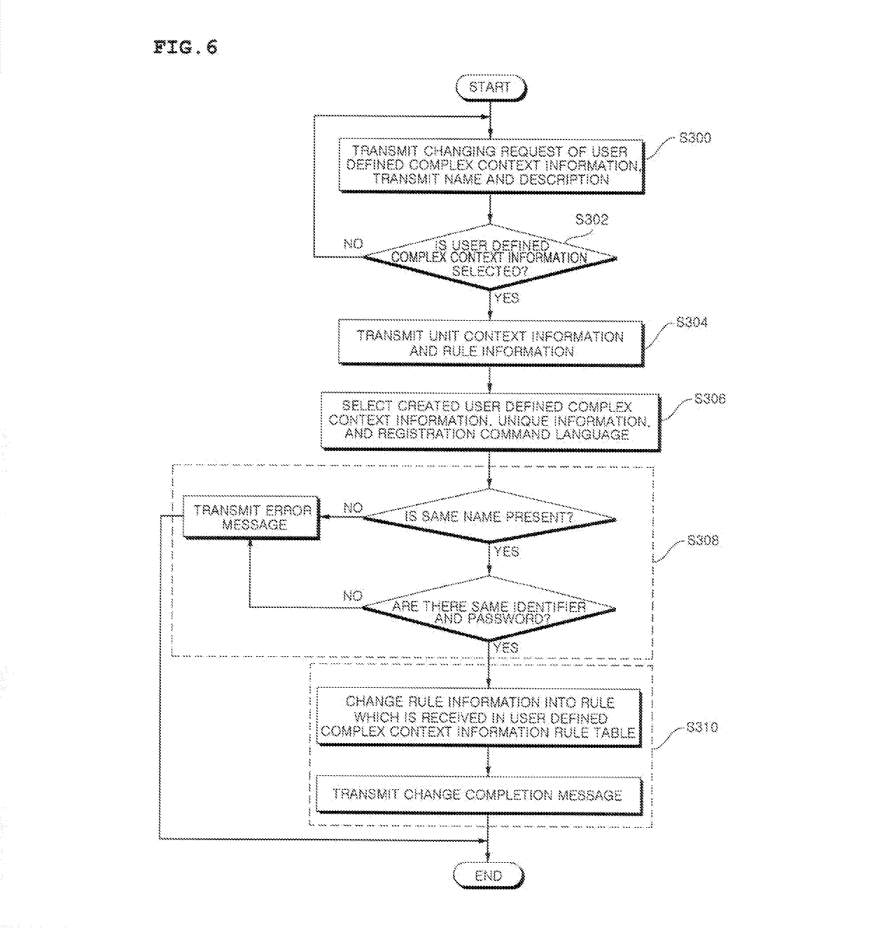

FIG. 6 is a flowchart illustrating a method of operating a user defined complex context information constitution system according to a second exemplary embodiment.

First, FIG. 6 illustrates an operating method of the arbitrary terminal device which changes the user defined complex context information.

Referring to FIG. 6, in step S300, a request for changing the user defined complex context information and the name and description of the user defined complex context information are input and transmitted from the arbitrary terminal device. In step S302, the system defined complex context information list which is registered in advance is transmitted to the terminal device and whether a selection command of arbitrary system defined complex context information from the system defined complex context information list is input from the terminal device is determined.

That is, the system defined complex context information constitution system 100 receives the change request, a name and a description of the user defined complex context information transmitted from the arbitrary terminal device and transmits the system defined complex context information list which is registered in advance. In this case, when the selection command for the arbitrary user defined complex context information from the system defined complex context information list is input from the terminal device, in step S304, the system defined complex context information constitution system 100 transmits screen information on a constitutional screen including unit context information from a system defined complex context information constitution table and rule information from a user defined complex context information rule table to the terminal device.

That is, when the selection command is input, the system defined complex context information constitution system 100 performs the user defined complex context information interface control function to transmit the unit context information which constitutes the arbitrary user defined complex context information selected by the terminal device from the user defined complex context information constitution table included in the user defined complex context information repository 120, and transmit the rule information, which describes the condition of the arbitrary system defined complex context information selected by the terminal device from the user defined complex context information rule table included in the user defined complex context information repository 120 and includes the value of the unit context information and the logical operator, to the terminal device so as to be constituted as the screen of the terminal device.

Thereafter, in step S306, the terminal device selects new unit context information which will be newly added to the unit context information list for the unit context information which constitutes the transmitted arbitrary system defined complex context information and adds a value of the added unit context information and a logical operator to create rule information of the user defined complex context information or change only new rule information and if the changed and created user defined complex context information, the unique information, and the selected changing command language are transmitted, the arbitrary user defined complex context information having the same name as the name in the user defined complex context information which is registered in advance is present and there are an identifier and a password same as the user identifier and password in step S308, in step S310, the user defined complex context information is changed and registered based on the user defined complex context information, the unique information, and the changing command language and the change completion is transmitted to the terminal device.

That is, the terminal device selects the changing command language among the unique information including the user identifier and password and the user defined complex context information constitution providing command language in order to change the rule information of the user defined complex context information to register the newly created user defined complex context information in the user defined complex context information constitution system 100 to transmit the changing command language to the user defined complex context information constitution system 100.

The user defined complex context information constitution system 100 performs the user defined complex context information interface control function to search the changing command language transmitted from the terminal device, the system defined complex context information list table, and the user defined complex context information list table which is registered in advance to search whether there is the same name.

In this case, if the same name is not present as the search result, the user defined complex context information constitution system 100 transmits the error information to the terminal device to constitute the screen.

If the same name is present, the user defined complex context information constitution system 100 changes the user defined complex context information including an identifier and a password which are the same as the user identifier and password information into the user defined complex context information which is received from the terminal device to be registered and then transmits a change completion message to the terminal device.

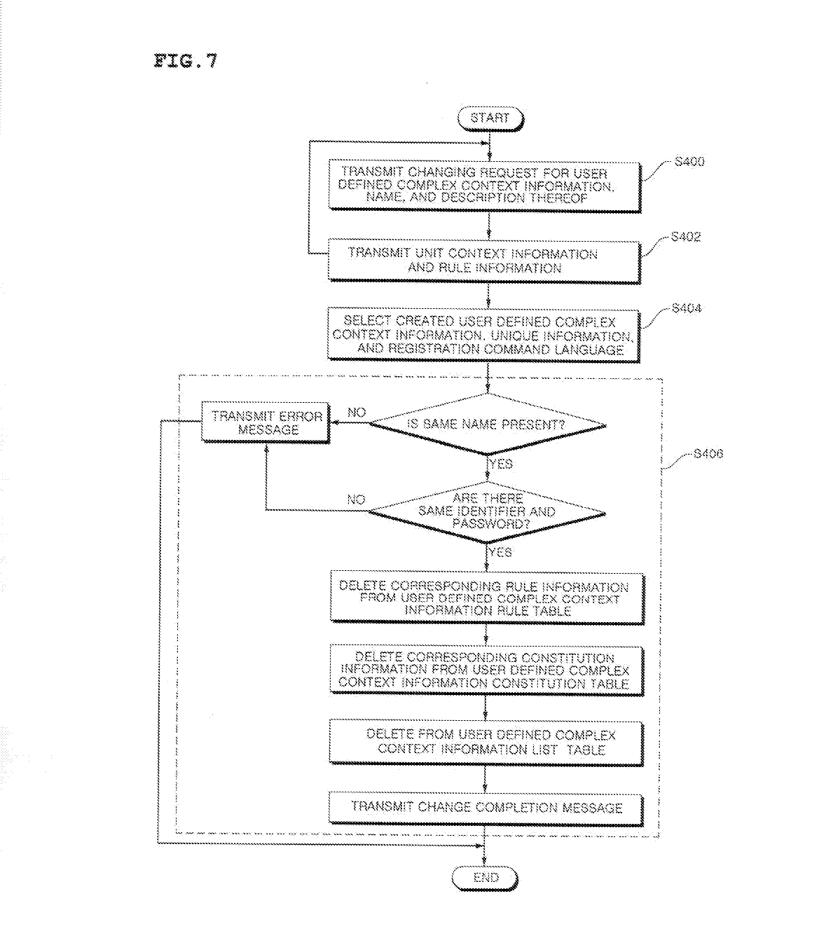

FIG. 7 is a flowchart illustrating a method of operating a user defined complex context information constitution system according to a third exemplary embodiment.

First, FIG. 7 illustrates an operating method of the arbitrary terminal device which deletes the user defined complex context information by the arbitrary terminal device.

Referring to FIG. 7, when the arbitrary terminal device requests to delete the user defined complex context information, in step S400, arbitrary user defined complex context information selected from the user defined complex context information which is registered in advance is transmitted. When a selection command for the arbitrary user defined complex context information is input, in step S402, screen information on a constitutional screen including unit context information from a user defined complex context information constitution table and rule information from a user defined complex context information rule table is transmitted to the terminal device.

That is, when the selection command is input, the user defined complex context information constitution system 100 performs the user defined complex context information interface control function to transmit the unit context information which constitutes the arbitrary user defined complex context information selected by the terminal device from the user defined complex context information constitution table included in the user defined complex context information repository 120 and transmit the rule information, which describes the condition of the arbitrary system defined complex context information selected by the terminal device from the user defined complex context information rule table included in the user defined complex context information repository 120 and includes the value of the unit context information and the logical operator to the terminal device so as to be constituted as the screen of the terminal device.

In step S404, a name, unique information, and a deletion command language on the arbitrary user defined complex context information are transmitted from the terminal device. If the same name as the name and the same unique information as the unique information are present, in step S406, the arbitrary user defined complex context information is deleted from the user defined complex context information list table, the user defined complex context information constitution table, and the user defined complex context information rule table in accordance with the deletion command language and the deletion completion is transmitted to the terminal device.

That is, the user defined complex context information constitution system 100 performs the user defined complex context information interface control function to search the deletion command language transmitted from the terminal device, the system defined complex context information list table, and the user defined complex context information list table, which is registered in advance, to search whether there is the same name.

In this case, if the same name is not present as the search result, the user defined complex context information constitution system 100 transmits the error information to the terminal device to constitute the screen.

If the same name is present, the user defined complex context information constitution system 100 deletes user defined complex context information having the same identifier and password as the user identifier and password information from the user defined complex context information list table, the user defined complex context information constitution table, and the user defined complex context information rule table and then transmits a deletion completion message to the terminal device

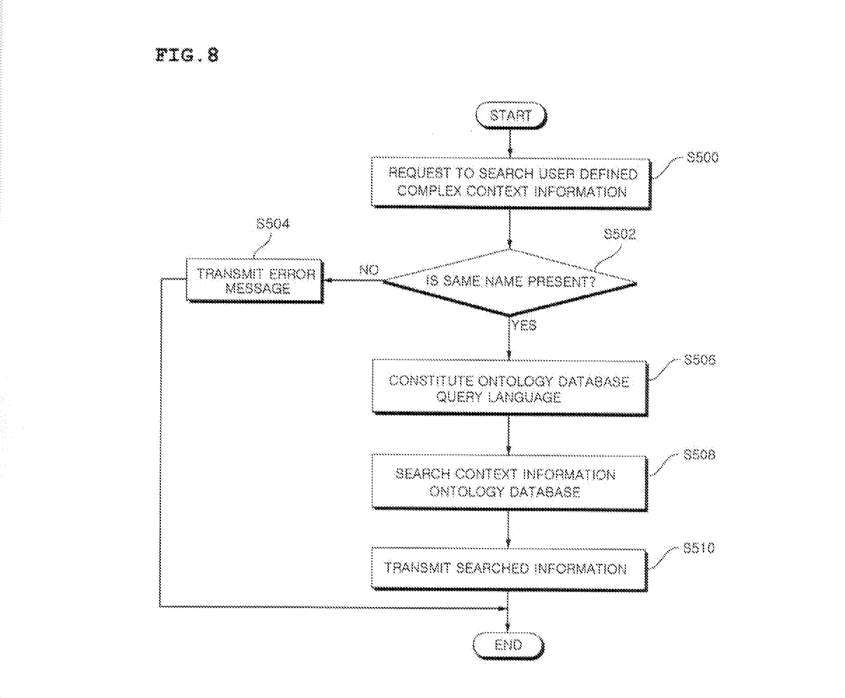

FIG. 8 is a flowchart illustrating a method of operating a user defined complex context information constitution system according to a fourth exemplary embodiment.

First, FIG. 8 illustrates an operating method of the arbitrary terminal device which searches the user defined complex context information.

Referring to FIG. 8, in step S500, if a request for searching all information which matches a user defined complex context information condition including a name of user defined complex context information and a user defined identification mark field on user defined complex context information is input from an arbitrary terminal device, in step S502, a user defined complex context information processing function is performed to check whether the received identification mark field is user defined complex context information and search whether there is the same name of user defined complex context information in the user defined complex context information list table included in a user defined complex context information repository. If there is no user defined complex context information having the same name as a searching result, in step S504, an error message is transmitted to the terminal device. If the same name is present as a searching result, in step S506, information related to the received complex context information name is extracted from the complex context information constitution table and the complex context information rule table associated with the complex context information list table to constitute an ontology database query language. In step S508, the information is searched in the context information ontology database 130 and in step S510, all information which matches the received user defined complex context information condition is collected to be transmitted to the terminal device.

As described above, the exemplary embodiments have been described and illustrated in the drawings and the specification. The exemplary embodiments were chosen and described in order to explain certain principles of the invention and their practical application, to thereby enable others skilled in the art to make and utilize various exemplary embodiments of the present invention, as well as various alternatives and modifications thereof. As is evident from the foregoing description, certain aspects of the present invention are not limited by the particular details of the examples illustrated herein, and it is therefore contemplated that other modifications and applications, or equivalents thereof, will occur to those skilled in the art. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. A method fox operating a user defined complex context information constitution system, comprising:
inputting a registration request for user defined complex context information corresponding to an arbitrary service and a name and a description of the user defined complex context information by an arbitrary terminal device;
transmitting a system defined complex context information list which is registered in advance in accordance with the service to the terminal device and determining whether a selection command for arbitrary system defined complex context information from the system defined complex context information list is input from the terminal device;
when the selection command is input, transmitting screen information on a constitutional screen including unit context information from a system defined complex context information constitution table and rule information from a system defined complex context information rule table to the terminal device;
receiving the user defined complex context information in which at least one of arbitrary unit context information of the unit context information and arbitrary rule information of the rule information is added to the arbitrary system defined complex context information, unique information, and a selected registration command language from the terminal device; and
registering the user defined complex context information and transmitting the registration completion to the terminal device, based on the user defined complex context information, the unique information, and the registration command language.

2. The method of claim 1, further comprising:
before the transmitting,
if there is no arbitrary user defined complex context information having the same name as the name in the user defined complex context information which is registered in advance, adding a name of the user defined complex context information and the unique information to a user defined complex context information list table, unit context information of the user defined complex context information to a user defined complex context information constitution table, and rule information of the user defined complex context information to the user defined complex context information rule table.

3. The method of claim 2, further comprising:
when there is the arbitrary user defined complex context information having the same name as the name, transmitting error information to the terminal device and returning to the inputting.

4. The method of claim 1, further comprising:
when the selection command is not input in the determining, determining whether to input a selection command for arbitrary user defined complex context information from a user defined complex context information list which is registered in advance; and
when the selection command is input, transmitting screen information on a constitutional screen including unit context information from a user defined complex context information constitution table and rule information from a user defined complex context information rule table to the terminal device.

5. The method of claim 4, further comprising:
receiving the user defined complex context information in which at least one of arbitrary unit context information of the unit context information and arbitrary rule information of the rule information is added to the arbitrary user defined complex context information, unique information, and a selected registration command language from the terminal device; and
registering the user defined complex context information and transmitting the registration completion to the terminal device, based on the user defined complex context information, the unique information, and the registration command language.

6. A method for operating a user defined complex context information constitution system, comprising:
transmitting an arbitrary user defined complex context information selected from user defined complex context information which is registered in advance, when an arbitrary terminal device inputs a request to change user defined complex context information corresponding to an arbitrary service;
transmitting screen information on a constitutional screen including unit context information from a user defined complex context information constitution table and rule information from a user defined complex context information rule table to the terminal device;
receiving the user defined complex context information in which at least one of arbitrary unit context information of the unit context information and arbitrary rule information of the rule information is added to the arbitrary user defined complex context information, unique information, and a selected changing command language from the terminal device; and
transmitting the change registration completion for the user defined complex context information to the terminal device, based on the user defined complex context information, the unique information, and the change command language.

7. The method of claim 6, further comprising:
before the transmitting,
if there is no arbitrary user defined complex context information having the same name as the name in the user defined complex context information which is registered in advance, adding a name of the user defined complex context information and the unique information to the user defined complex context information list table, unit context information of the user defined complex context information to a user defined complex context information constitution table, and rule information of the user defined complex context information to the user defined complex context information rule table.

8. The method of claim 6, wherein the transmitting to the terminal device includes:
when there is the arbitrary user defined complex context information having the same name as the name, determining whether there is the arbitrary user defined complex context information having the same unique information as the unique information; and
when there is the arbitrary user defined complex context information having the same unique information as the unique information, transmitting the change registration completion for the user defined complex context information transmitted from the terminal device to the terminal device.

9. A method for operating a user defined complex context information constitution system, comprising:
transmitting arbitrary user defined complex context information selected from user defined complex context information which is registered in advance, when an arbitrary terminal device inputs a request to delete user defined complex context information corresponding to an arbitrary service;
transmitting screen information on a constitutional screen including unit context information from a user defined complex context information constitution table and rule information from a user defined complex context information rule table to the terminal device;
receiving a name, unique information, and a deleting command language for the arbitrary user defined complex context information, from the terminal device; and
when there are the same name as the name and the same unique information as the unique information, deleting the arbitrary user defined complex context information from a user defined complex context information list table, a user defined complex context information constitution table, and a user defined complex context information rule table in accordance with the deleting command language and transmitting the deleting completion to the terminal device.

10. A method for operating a user defined complex context information constitution system, comprising:
searching arbitrary user defined complex context information which matches a user defined complex context information condition including a name of input user defined complex context information and a user defined identification mark field when an arbitrary terminal device inputs a request to search the user defined complex context information;
confirming whether the identification mark field is user defined complex context information and determining whether there is the arbitrary user defined complex context information having the same name as the name in the user defined complex context information list table included in a user defined complex context information repository;
if the arbitrary user defined complex context information is present, extracting information related to the name from the complex context information constitution table and the complex context information rule table included in the user defined complex context information repository to constitute an ontology database query language; and
transmitting all information on the arbitrary user defined complex context information from the context information ontology database based on the ontology database query language to the terminal device.

11. The method of claim 10, wherein the determining includes when there is no arbitrary user defined complex context information, transmitting an error message to the terminal device.
